(19) United States
(12) Patent Application Publication
(10) Pub. No.: US 2008/0050086 A1
(43) Pub. Date: Feb. 28, 2008

(54) Optical fiber containing alkali metal oxide

(76) Inventors: Scott Robertson Bickham, Corning, NY (US); Snigdharaj Kumar Mishra, Wilmington, NC (US)

Correspondence Address: CORNING INCORPORATED, SP-TI-3-1, CORNING, NY, 14831, US

(21) Appl. No.: 11/891,274

(22) Filed: Aug. 9, 2007

Related U.S. Application Data
(60) Provisional application No. 60/839,743, filed on Aug. 24, 2006.
(60) Provisional application No. 60/849,732, filed on Oct. 5, 2006.

(51) Int. Cl. G02B 6/00

(52) U.S. Cl. 385/142

(57) ABSTRACT

Disclosed is an optical fiber having a silica-based core comprising an alkali metal oxide a silica-based core, said core comprising an alkali metal oxide selected from the group consisting of K₂O, Na₂O, LiO₂, Rb₂O, Cs₂O and mixtures thereof in an average concentration in said core between about 50 and 1000 ppm by weight, and a silica-based cladding surrounding and directly adjacent the core, said fiber comprising a cable cutoff less than 1400 nm chromatic dispersion at 1550 nm between about 13 and 19 ps/nm/km and a zero dispersion wavelength less than about 1324 nm. By appropriately selecting the concentration of alkali metal oxide dopant in the core and the cladding, a low loss optical fiber may be obtained.

### CROSS-REFERENCE TO RELATED APPLICATIONS

This application claims the benefit of priority under 35 U.S.C. § 119(e) of U.S. Provisional Application Ser. No. 60/839,743 filed on Aug. 24, 2006, and U.S. Provisional Application Ser. No. 60/849,732 filed on Oct. 5, 2006, the contents of which are relied upon and incorporated herein by reference in their entirety.

### BACKGROUND OF THE INVENTION

1. Field of the Invention

The present invention relates generally to an optical fiber doped with an alkali metal oxide and methods and apparatus for making same.

2. Technical Background

Attenuation is a principal limiting attribute of optical fibers. Optical fiber loss, for example, plays an important role in setting the limiting distance between optical fiber amplifiers. This is particularly important in long distance and ultra-long distance networks such as, for example, undersea applications, where such amplifiers represent a significant system cost, as well as a major factor in system reliability. Consequently there is tremendous commercial interest in reducing attenuation to the lowest possible level.

### SUMMARY OF THE INVENTION

One broad aspect of the present invention relates to an optical fiber comprising a silica-based core, said core comprising an alkali metal oxide selected from the group consisting of K₂O, Na₂O, LiO₂, Rb₂O, Cs₂O and mixtures thereof in an average concentration in said core between about 50 and 1000 ppm by weight, and a silica-based cladding surrounding and directly adjacent the core. The fiber comprises a cable cutoff less than 1400 nm, more preferably less than 1300, and most preferably less than 1260 nm. The fiber comprises a chromatic dispersion at 1550 nm between about 13 and 19 ps/nm/km, more preferably between 14 and 18 ps/nm/km. The optical fiber also exhibits a zero dispersion wavelength less than about 1420 nm, preferably less than about 1324 nm, and preferably exhibits a dispersion slope less than about 0.092 ps/nm/km at 1310 nm, more preferably less than or equal to about 0.090 ps/nm/km at 1310 nm. The optical fiber also preferably exhibits a mode field diameter greater than about 9.5 μm and an effective area greater than about 70 μm² at 1550 nm, more preferably a mode field diameter greater than about 10.0 μm and an effective area greater than about 75 μm² at 1550 nm.

The alkali metal oxide is preferably present in the core in an average concentration in said core between about 50 and 500 ppm by weight, more preferably between about 100 and 300 ppm by weight. The core of the optical fiber preferably contains substantially no germania, and preferably no germania dopant. The core may include fluorine, and in some embodiments the average concentration of fluorine in said core is preferably greater than the average concentration of alkali metal oxide in said core. The core of the fiber as well as the cladding of the optical fiber may additionally include chlorine, and in some preferred embodiments the average concentration of chlorine in said core is preferably greater than the average concentration of alkali metal oxide in said core. By average concentration as used herein, we mean the average concentration over the entire core. Thus, for example, if the inner 50 percent of the core exhibits 300 ppm by weight K₂O, and the outer 50 percent of the core exhibits 400 ppm by weight K₂O, the average concentration of K₂O in the core would be 350 ppm. K₂O is the post preferred alkali metal oxide for doping in accordance with the invention.

The core of said fiber preferably comprises chlorine in an average concentration in said core greater than about 750 ppm by weight. The cladding is a silica-based cladding which surrounds and preferably is directly adjacent the core. The cladding preferably contains fluorine in an amount greater than 10000 ppm. The core preferably consists essentially of no germanium, and more preferably the core is germanium free.

In one preferred embodiment, the core of said fiber comprises a first region located along the centerline of the core which contains chlorine in an amount less than 100 ppm, and a second core region surrounding said first region, wherein said chlorine content is greater than 100 ppm. The first region also preferably comprises a maximum fluorine amount which is greater than the minimum fluorine content in said second region.

The average concentration of chlorine in the core is preferably greater than 500, more preferably greater than 750 ppm, even more preferably greater than 1000 ppm, and most preferably greater than about 1500 ppm. The average concentration of fluorine in the core is preferably greater than 500, more preferably greater than 750 ppm, even more preferably greater than 1000 ppm, and most preferably greater than about 1500 ppm.

Using the alkali metal oxide doping techniques disclosed herein, optical fibers can be made which exhibit an attenuation less than about 0.30 dB/km at 1310 nm and less than about 0.175 dB/km at 1550 nm; preferably less than about 0.170 dB/km at 1550 nm, more preferably less than about 0.16 dB/km at 1550 nm.

Preferably, both the core and the cladding of the optical fiber contain an alkali metal oxide dopant. The optical fiber has at least one core segment; however, this is not critical and the optical fiber may alternatively comprise multiple core segments.

The core of the optical fiber preferably contains less than 20 ppb of OH.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention. Where appropriate, identical features have been identically numbered.

### BRIEF DESCRIPTION OF THE DRAWINGS

FIG. 1 is an illustration of a step index optical fiber refractive index profile in accordance with the invention.

FIG. 2 is an illustration of a step index optical fiber refractive index profile in accordance with the invention.

FIG. 3 illustrates a method of manufacturing an alkali metal oxide-doped optical fiber according to the present invention.

FIG. 4 shows a method of depositing glass soot.

FIG. 5 depicts a method for doping a glass tube with an alkali metal oxide.

FIG. 6 illustrates a process for drawing a glass rod.

### DETAILED DESCRIPTION OF THE INVENTION

The present invention relates to a low loss optical fiber and methods for making the same. More specifically, the invention relates to an optical fiber doped with an alkali metal oxide dopant and methods for manufacturing the optical fiber and associated preforms. The following terms as used herein have the following meanings:

The mode field diameter is a measure of optical power across the endface of a single-mode optical fiber, and is expressed as:

2ω₀=(λ/π)[2∫I(Φ)sin Φ cos ΦdΦ)/∫I(Φ)sin³Φ cos ΦdΦ]^{1/2} (1)

where 2ω₀ is the mode field diameter (and therefore ω₀ is the mode field radius), λ is the mean wavelength of the light, Φ is the angle with respect to the center of the radiation pattern, and the integrations are preferably carried out from 0° to 90°. Mode field diameter may be measured, for example, according to test procedure ANSI/TIA/EIA-455-191-A-2001.

Effective area is

A_{eff}=2π(∫E²r dr)²/(∫E⁴r dr) (2)

where the integration limits are 0 to ∞, and E is the electric field associated with the propagated light.

The cabled cutoff wavelength, or “cabled cutoff is even lower than the measured fiber cutoff due to higher levels of bending and mechanical pressure in the cable environment. The actual cabled condition can be approximated by the cabled cutoff test described in the EIA-445 Fiber Optic Test Procedures, which are part of the EJA-TIA Fiber Optics Standards, that is, the Electronics Industry Alliance—Telecommunications Industry Association Fiber Optics Standards, more commonly known as FOTP's. Cabled cutoff measurement is described in EIA-455-170 Cable Cutoff Wavelength of Single-mode Fiber by Transmitted Power, or “FOTP-1 70”. As used herein cable cutoff means the value obtained using the test described in the EIA-445 Fiber Optic Test Procedures.

The pin array bend test is used to compare relative resistance of waveguide fibers to bending. To perform this test, attenuation loss is measured for a waveguide fiber with essentially no induced bending loss. The waveguide fiber is then woven about the pin array and attenuation again measured. The loss induced by bending is the difference between the two measured attenuations. The pin array is a set of ten cylindrical pins arranged in a single row and held in a fixed vertical position on a flat surface. The pin spacing is 5 mm, center to center. The pin diameter is 0.67 mm. The waveguide fiber is caused to pass on opposite sides of adjacent pins. During testing, the waveguide fiber is placed under a tension just sufficient to make the waveguide conform to a portion of the periphery of the pins.

Another bend test referenced herein is the lateral load wire mesh bend test (LLWM). In this test a prescribed length of waveguide fiber is placed between two flat plates. A #70 wire mesh is attached to one of the plates. (The market code #70 mesh is descriptive of screen made of wire having a diameter of 0.178 mm. The screen openings are squares of side length 0.185 mm.) A known length of waveguide fiber is sandwiched between the plates and a reference attenuation is measured while the plates are pressed together with a force of 30 newtons. A 70 newton force is then applied to the plates and the increase in attenuation in dB/m is measured. This increase in attenuation is the lateral load attenuation of the waveguide.

The relative refractive index, Δ, is defined by the equation Δᵢ=(nᵢ²−n_{c}²)/2nᵢ², where nᵢ is the maximum refractive index of the index profile segment i, and n_{c} is the refractive index of the outer cladding layer. The relative refractive index is generally expressed as a percent and is indicated herein by the term % Δ. Unless otherwise indicated, % Δ represents the maximum relative refractive index of a particular segment of the refractive index profile relative to the refractive index of the outer cladding.

The term refractive index profile or simply index profile is the relation between % Δ and radius over a selected portion of the optical fiber, typically the core.

The term alpha profile refers to a core refractive index profile which follows the equation,

n(r)=n₀(1−[r/a]^{α}) (3)

where r is core radius, a is the last point in the profile, r is chosen to be zero at the first point of the profile, n₀ is the maximum refractive index of the core region of interest, and α is an exponent which defines the core profile shape. Other common core refractive index profile shapes include a step index, a trapezoidal index and a rounded step index, in which the rounding is due to dopant diffusion in regions of rapid refractive index change.

Core refers to that portion of the optical fiber which has a generally raised index of refraction relative to the cladding, so that the transmitted optical power propagates predominately through the core. The core may be comprised of one or more segments. An individual core segment may have a refractive index greater than pure silica, equal to pure silica, or less than pure silica.

“ppm”, unless otherwise specifically noted otherwise, refers to parts per million by weight, or “ppm by weight”, or “ppm by wt.”, and a measurement in weight percent (wt %) can be converted to ppm by multiplying by a factor of 10,000.

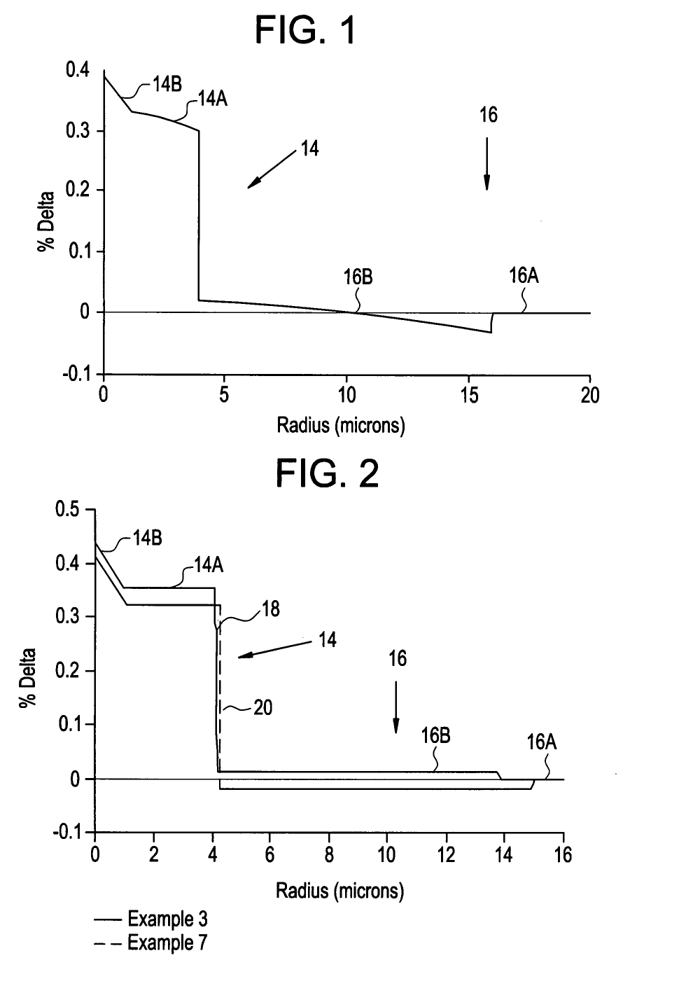

As illustrated in FIGS. 1 and 2, in preferred embodiments, the optical fiber disclosed herein preferably comprises a core and a cladding surrounding the core. Preferably, the cladding surrounds and is directly adjacent the core. Preferably, the core contains essentially no germania, more preferably the core contains no germania. In some preferred embodiments, the core consists of a single core segment, namely a central core segment 14, and a cladding 16 surrounding and directly adjacent the central core segment, as represented by FIG. 1 and variations of the illustrative profile of FIG. 1, such as profiles having a step, rounded, alpha or triangular shape, wherein the central core segment has a positive refractive index Δ₁(r) relative to the cladding. In other preferred embodiments, the core comprises multiple core segments, such as a central core segment and a first annular core segment surrounding and directly adjacent the central core segment, and a cladding surrounding and directly adjacent the first annular core segment, wherein the central core segment has a non-negative, preferably positive, relative refractive index Δ₁% (r) relative to the cladding, and wherein the first annular core segment pure silica, has a non-negative, preferably positive, relative refractive index Δ₂% (r) relative to the cladding.

In the embodiments illustrated in FIGS. 1 and 2, the core segment 14 preferably extends to about 2 to 8, more preferably 3 to 6, and most preferably 3.5 to 4.5 microns from the center of the optical fiber, and the cladding portion 16 extends from the outer radius of the core to the outermost radius of the optical fiber. As illustrated in FIGS. 1 and 2, the preferred embodiments employ at least a first core region 14A which comprises index of refraction Δ₁ and a cladding region 16 comprising index of refraction Δ₂ which is lower than Δ₁. The average refractive index over the entire core segment 14 preferably is between about 0.25 and 0.45, more preferably between about 0.3 and 0.4. Preferred values of A₁ for region 14A are between about 0.25 and 0.45, more preferably between about 0.30 and 0.35. Region 14A may continue its slope across to the centerline of the fiber or, alternatively, core region 14 may optionally also include region 14B which includes Δ₀ which is preferably larger than Δ₁ if region 14B is employed. If core region 14B is employed along the centerline of the optical fiber, the preferred values for peak refractive index Δ₀ for region 14B are between about 0.25 and 0.60, more preferably between about 0.36 and 0.46, and preferably region 14B if employed has a peak refractive index which is higher than that of core region 14A. Thus, in preferred embodiments, the core segment 14 comprises a higher refractive index along the centerline of the optical fiber than near the outermost portion of the core region 14. A near cladding region 16B of cladding 16 may also or alternatively be employed which has a refractive index different than that of outer cladding region 16A. As illustrated in FIG. 2, the refractive index delta Δ₃ of near cladding region 16B can be larger than, equal to, or less than that of the outer cladding 16A. In some preferred embodiments, the refractive index delta Δ₃ of near cladding region 16B is less than that of the outer cladding 16A. If near cladding region 16B is employed, the preferred value for refractive index Δ₃ of this region is between about −0.1 to 0.1, more preferably between about −0.03 to 0.03.

The core region comprises an alkali metal oxide selected from the group consisting of K₂O, Na₂O, LiO₂, Rb₂O, Cs₂O and mixtures thereof (in this case K₂O) in an average concentration in said core between about 50 and 1000 ppm by weight. The core further comprises chlorine and fluorine. Preferably, the average concentration of fluorine in said core is greater than the average amount of alkali metal oxide in said core and the average amount of chlorine in said core is greater than the average amount of alkali metal oxide in said core. The fiber also includes a fluorine doped silica-based cladding which surrounds and in some preferred embodiments is directly adjacent the core.

In some preferred embodiments, the core region comprises a first central core region (extending to about 1 micron) located along the centerline of the core which preferably contains a lower average concentration of chlorine than is contained in the outer region (i.e., extending from about 1 to about 4 microns) of the core. In particular, the average concentration of chlorine present in the central core region may be less than 100 ppm, more preferably less than 50 ppm, and the average concentration of chlorine in the second or outer core region which surrounds the first region may be greater than 500 ppm, more preferably greater than 750 ppm, even more preferably greater than 1000 ppm, and most preferably greater than 1500 ppm. The peak concentration of chlorine in the core region is preferably greater than 500 ppm, more preferably greater than 1000 ppm, and most preferably greater than 1500 ppm.

The average concentration of fluorine present in the central core region is preferably greater than 500 ppm, more preferably greater than 750 ppm, and most preferably greater than 1000 ppm, and the average concentration of fluorine in the second or outer core region which surrounds the first region is likewise preferably greater than 500 ppm, more preferably greater than 750 ppm, and most preferably greater than 1000 ppm.

The average concentration of fluorine across the entire core region is preferably greater than 500 ppm, more preferably greater than 750 ppm, and most preferably greater than 1000 ppm, and preferably less that 5000 ppm, more preferably less than 4000 ppm. In the embodiment illustrated, the peak concentration of the chlorine in said second core region is higher than the peak concentration of fluorine in said second region, although this relationship is not critical. Preferably, the average concentrations of both chlorine and fluorine in the core region are greater than about 500 ppm, more preferably greater than about 750 ppm, and most preferably greater than about 1000 ppm.

In some preferred embodiments, the optical fiber disclosed herein comprises a single core segment, namely a central core segment, and a cladding surrounding and directly adjacent the central core segment, wherein the cladding has a negative refractive index relative to pure silica, and wherein the core comprises fluorine and an alkali metal oxide selected from the group consisting of K₂O, Na₂O, LiO₂, Rb₂O, Cs₂O and mixtures thereof, with a peak alkali metal oxide concentration of between 20 and 700 ppm, preferably between 50 and 500 ppm, even more preferably between 100 and 400 ppm.

The core region 14A of the fiber comprises a peak relative refractive index delta (relative to the cladding), Δ_{MAX}, between 0.2 and 0.5%, preferably between 0.3 and 0.4%. The optical fiber comprises greater than 90 wt % SiO2, preferably greater than or equal to 95 wt % SiO₂.

Examples of such fibers in accordance with the invention are set forth in Table 1, which provides the refractive index Δ₀ of inner core segment 14B, the average refractive index of core segment 14 (delta average) the average refractive index Δ₁ of outer core segment 14B, the outer radius of core segment 14 (radius 1), and the refractive index Δ₂ and radius (radius 2) of near clad segment 16B for a variety of examples in accordance with the invention. In all of the examples, no germanium is employed in the core, and the cladding comprises fluorine doped silica. Thus, the refractive index deltas of the individual segments are taken with respect to the outer fluorine doped cladding region. Also set forth in Table 1 for each example is dispersion at 1310 nm, dispersion slope at 1310 nm, zero dispersion wavelength, dispersion at 1550 nm, dispersion slope at 1550 nm, cable cutoff wavelength, mode field diameter at 1310 nm and 1550 nm, Effective Area at 1550 nm, pin array bend loss at 1550 nm, lateral load bend loss (LLWM) at 1550 nm. Example 1 in Table 1 corresponds to the embodiment illustrated in FIG. 1. 1350 km of the fiber set forth in FIG. 1 were drawn and tested. The fiber exhibit a mean attenuation of 0.169 dB/km at 1550 nm, a minimum attenuation value of 0.162 dB/km, and a mean attenuation of 0.285 dB/km at 1310 nm with a minimum attenuation value at 1310 nm of 0.275 dB/km. Examples 3 and 7 correspond to lines 18 and 20 in FIG. 2.

TABLE 1

| | 14B Δ₀ | 14 Δ | 14A Δ₁ | 16B Δ₂ | | |
|---|---|---|---|---|---|---|
| Example | (max) | (average) | (average) | (average) | Radius 1 | Radius 2 |
| 1 | 0.39 | 0.33 | 0.32 | 0 | 3.9 | — |
| 2 | 0.455 | 0.36 | 0.345 | 0.019 | 4.35 | 13.39 |
| 3 | 0.440 | 0.36 | 0.355 | 0.014 | 4.15 | 13.86 |
| 4 | 0.429 | 0.35 | 0.345 | 0.019 | 4.19 | 12.76 |
| 5 | 0.394 | 0.34 | 0.332 | 0.022 | 4.33 | 14.56 |
| 6 | 0.419 | 0.35 | 0.342 | −0.021 | 4.19 | 16.51 |
| 7 | 0.408 | 0.34 | 0.326 | −0.018 | 4.38 | 16.76 |
| 8 | 0.425 | 0.34 | 0.334 | 0.000 | N/A | N/A |
| 9 | 0.436 | 0.36 | 0.360 | 0.047 | 3.91 | 10.81 |
| 10 | 0.395 | 0.35 | 0.345 | 0.000 | 3.60 | 16.50 |
| 11 | 0.417 | 0.373 | 0.367 | 0.025 | 3.60 | 16.50 |
| 12 | 0.452 | 0.375 | 0.365 | 0.050 | 3.83 | 12.10 |
| Conventional | N/A | 0.34 | 0.340 | 0.000 | 4.5 | N/A |
| Single Mode | | | | | | |

| | | | Zero | | | Cable |
|---|---|---|---|---|---|---|
| | Disp 1310 | Slope 1310 | Dispersion | Disp 1550 | Slope 1550 | Cutoff |
| Example | (ps/nm/km) | (ps/nm2/km) | (nm) | (ps/nm/km) | (ps/nm2/km) | (nm) |
| 1 | −0.39 | 0.083 | 1314 | 16.02 | 0.058 | 1190 |
| 2 | 0.30 | 0.087 | 1307 | 17.10 | 0.058 | 1245 |
| 3 | −0.26 | 0.086 | 1313 | 16.34 | 0.058 | 1195 |
| 4 | −0.25 | 0.086 | 1313 | 16.44 | 0.058 | 1198 |
| 5 | 0.07 | 0.086 | 1309 | 16.86 | 0.058 | 1211 |
| 6 | 0.27 | 0.086 | 1307 | 16.82 | 0.057 | 1158 |
| 7 | 0.71 | 0.086 | 1302 | 17.42 | 0.058 | 1173 |
| 8 | 0.46 | 0.086 | 1305 | 17.19 | 0.058 | 1195 |
| 9 | −1.47 | 0.086 | 1327 | 15.47 | 0.060 | 1208 |
| 10 | −0.73 | 0.084 | 1319 | 14.94 | 0.055 | 1198 |
| 11 | −0.74 | 0.083 | 1319 | 15.73 | 0.058 | 1196 |
| 12 | −1.90 | 0.086 | 1333 | 14.92 | 0.060 | 1209 |
| Conventional | 0.00 | 0.086 | 1300 | 16.65 | 0.058 | 1175 |
| Single Mode | | | | | | |

| | | | Aeff 1550 | | | | D/atten |
|---|---|---|---|---|---|---|---|
| | MFD 1310 | MFD 1550 | (sq. | Pin Array | | 1550 nm | at |
| Example | (microns) | (microns) | microns) | (dB) | LLWM (dB) | atten | 1550 |
| 1 | 9.2 | 10.69 | 85.8 | 16.12 | 0.88 | 0.170 | 94.2 |
| 2 | 9.28 | 10.51 | 84.7 | 4.85 | 0.47 | 0.180 | 95 |
| 3 | 8.99 | 10.24 | 80.0 | 6.18 | 0.44 | 0.180 | 90.8 |
| 4 | 9.16 | 10.45 | 83.2 | 7.30 | 0.57 | 0.175 | 93.9 |
| 5 | 9.44 | 10.76 | 88.3 | 8.42 | 0.88 | 0.170 | 99.2 |
| 6 | 8.86 | 10.02 | 77.1 | 10.75 | 0.45 | 0.175 | 96 |
| 7 | 9.15 | 10.32 | 82.1 | 11.58 | 0.56 | 0.170 | 102 |
| 8 | 9.22 | 10.43 | 83.5 | 8.38 | 0.53 | 0.175 | 98.2 |
| 9 | 9.14 | 10.58 | 84.2 | 6.78 | 0.76 | 0.175 | 88.4 |
| 10 | 8.51 | 9.87 | 73.5 | 15.82 | 0.61 | 0.175 | 85.4 |
| 11 | 9.01 | 10.48 | 82.2 | 23.99 | 1.04 | 0.170 | 92.5 |
| 12 | 9.05 | 10.52 | 83.0 | 6.16 | 0.92 | 0.175 | 85.2 |
| Conventional | 9.16 | 10.42 | 82.8 | 11.80 | 0.65 | 0.192 | 86.7 |
| Single Mode | | | | | | | |

Preferably, both the core and the cladding of the optical fiber contain an alkali metal oxide dopant. The alkali metal oxide is preferably an oxide of K, Na, Li, Cs, or Rb, or a mixture thereof; more preferably the alkali metal oxide is K₂O, Rb₂O, Cs₂O or mixtures thereof; and most preferably the alkali metal oxide is K₂O. Preferably, the alkali metal oxide has a peak concentration in the core of the optical fiber. The alkali metal oxide concentration may vary radially across the radius of the optical fiber, and in some cases may decrease as a function of increasing radius from the centerline of the optical fiber along at least a portion of the optical fiber radius.

In the embodiments illustrated in FIGS. 1 and 2, refractive index profile 10 has a single core segment, which is surrounded by cladding segment 16. Preferably, the alkali metal oxide concentration varies as a function of radius. Preferably, the concentration of alkali metal oxide generally decreases as a function of increasing radius from the centerline of the optical fiber along at least a portion of the optical fiber radius. Core segment 14 of the optical fiber may have a step shape as shown in FIGS. 1 and 2, or core segment 14 may have a rounded, alpha or triangular shape.

The fibers of the present invention preferably consist essentially of no germanium in the core thereof. Instead, the cladding of the optical fibers contain enough index of refraction reducing dopant in the cladding to form a refractive index profile such as is illustrated in FIG. 1. In such embodiments, the refractive index of cladding segment 16 is less than pure silica and, of course, less than the core 14. The preferred index of refraction decreasing dopant for use in the cladding of optical fibers disclosed herein is fluorine.

In one embodiment according to the present invention, the refractive index profile of the optical fiber such as those disclosed in FIGS. 1 and 2 are tailored to result in a single mode optical fiber which preferably has a zero dispersion wavelength, λ₀, less than 1420 nm, more preferably less than 1324 nm and most preferably between about 1280 nm and 1324 nm, a zero dispersion slope, Sₒ, less than about 0.09 ps/nm²/km, a dispersion slope at 1550 which is less than about 0.07 ps/nm²/km, more preferably less than about 0.065 ps/nm²/km, and most preferably less than about 0.06 ps/nm²/km, and a total dispersion between about 13 and 19 ps/nm/km at 1550 nm, more preferably between about 14 ps/nm/km and 18 ps/nm/km at 1550 nm. However, other refractive index profiles could be used to achieve these same properties. Preferably, the optical fiber has a cable cutoff wavelength less than about 1300 nm, more preferably less than about 1260 nm. Preferably the optical fiber has an effective area greater than about 70 μm² at 1550 nm, more preferably greater than about 75 μm² at 1550 nm. The optical fiber preferably has a core diameter greater than about 3 μm, more preferably between about 3 μm and 5 μm, and a mode field diameter greater than about 9.5 μm, more preferably between about 10 μm and 11 μm at 1550 nm. By including an alkali metal oxide in accordance with the invention, optical fibers may be made which have an attenuation less than about 0.30 dB/km at 1310 nm and less than about 0.18 dB/km at 1550 nm; more preferably less than about 0.17 dB/km at 1550 nm, and most preferably less than about 0.16 dB/km at 1550 nm. In one preferred embodiment of the invention, illustrated for example by Examples 9-12, the fibers of the present invention exhibit an attenuation of less than 0.18 dB/km at 1550, more preferably less than 0.17 dB/km, and the dispersion/attenuation at 1550 nm is greater than 80, more preferably greater than 90. In some preferred embodiments, the dispersion/attenuation at 1550 nm is between about 80 and 110, even more preferably between 80 and 100. The dispersion of the fibers in these embodiments is preferably less than 18 ps/nm/km, more preferably less than 17 ps/nm/km, and most preferably less than 16 ps/nm/km.

The diffusion of an alkali metal oxide may be advantageously controlled during the draw process. It has been found that by varying draw conditions in a prescribed manner, alkali metal oxide dopants may be distributed throughout the preform in a desired concentration profile. Preferably, the alkali metal oxide dopant is diffused in a relatively linear relationship with respect to radius. Because the diffusion of an alkali metal oxide dopant is partially dependent upon the temperature of the glass being doped, and the time the glass remains at the temperature, these same factors play a significant role in controlling the alkali metal oxide diffusion during the draw process. The time and the temperature to which an optical fiber preform (and the optical fiber drawn from the preform) are exposed during the draw process are controlled by varying the draw speed, the draw (furnace) temperature and optical fiber tension. For example, increasing the draw speed decreases the dwell time for a particular section of the optical fiber preform in the draw furnace, thus decreasing the distance which an alkali metal oxide dopant will diffuse across the optical fiber preform, and hence the drawn optical fiber. This may result in less alkali metal oxide diffusing into the cladding and, therefore, a higher alkali metal oxide concentration in the core of the optical fiber. Conversely, decreasing the draw speed increases the dwell time, and, therefore, may result in an decrease in the concentration of alkali metal oxide in the core of the optical fiber as the alkali metal oxide diffuses further into the cladding of the optical fiber. In a like manner increasing the furnace temperature may increase the diffusion rate of the alkali metal oxide, decreasing the concentration of alkali metal oxide. Consequently, draw speed and furnace temperature may be effectively used to control the diffusion, and thus the distribution of alkali metal oxide within the resulting optical fiber.

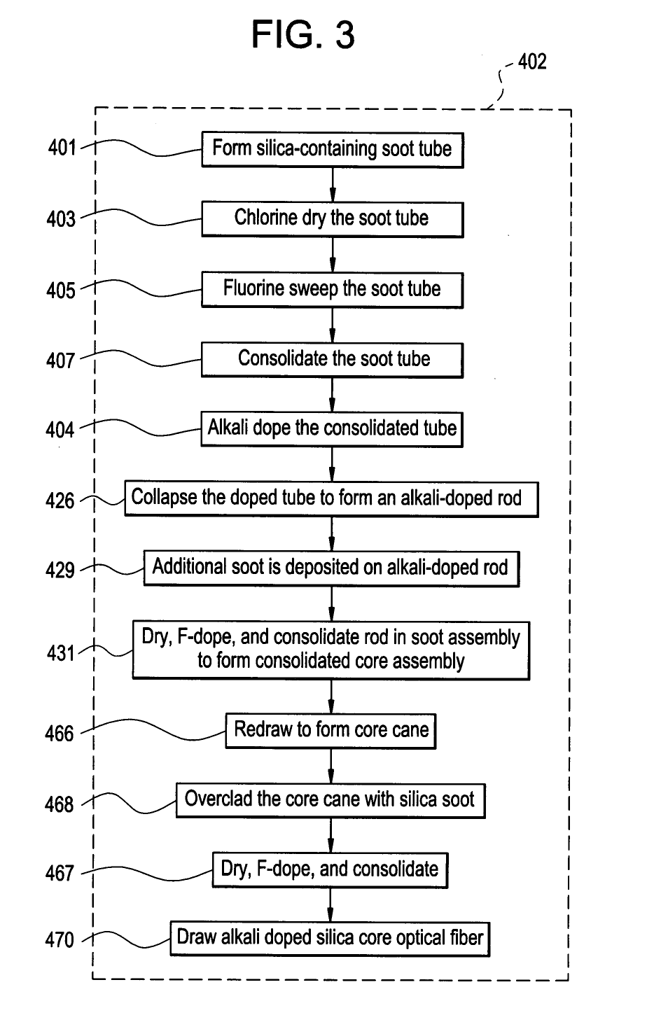

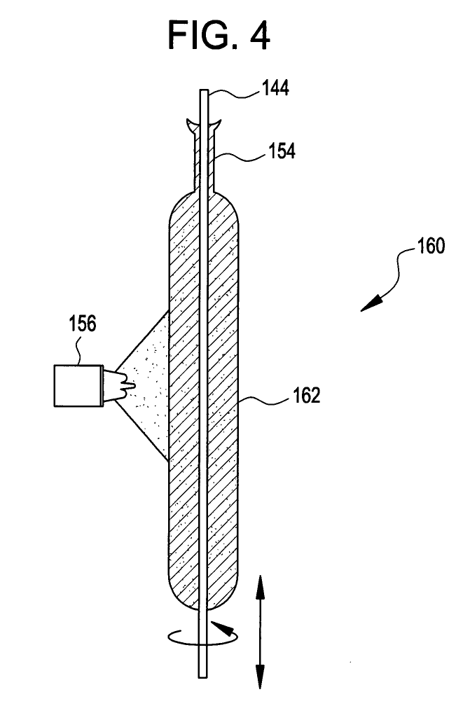

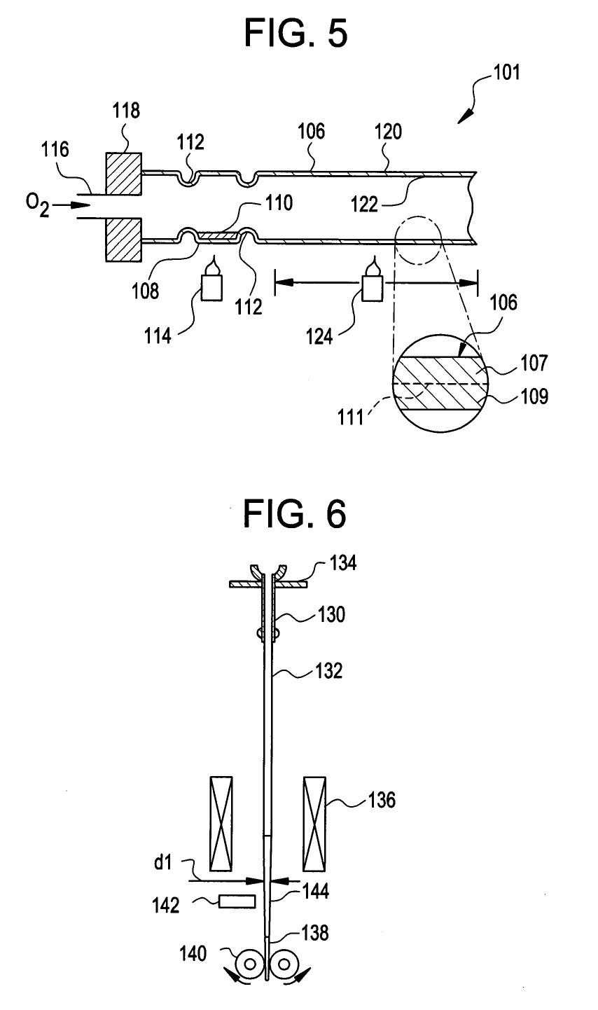

Illustrated in FIG. 3 is a first method 402, in accordance with embodiments of the present invention, for producing an alkali-doped optical fiber by diffusing an alkali metal oxide into a suitable silica glass article that is a precursor to an optical fiber. A first step 401 of the method 402 is shown and described with reference to FIGS. 4 and 5. Referring to FIG. 4 which is an illustration of a conventional outside vapor deposition process, a soot burner 156 is used to deposit multiple layers of silica soot 162 onto a mandrel 144 to form soot preform 160. The resultant soot preform is then dried (step 403) using standard chlorine drying techniques. The soot is then doped with fluorine (step 405) by exposing the soot to an atmosphere of a fluorine containing compound (e.g. SiF₄) for a time and at a temperature sufficient to result in removal of much or all of the chlorine remaining from the drying step. The exposure to a fluorine-containing atmosphere (fluorine sweep) is done at temperatures preferably less than about 1100° C. to avoid doping the glass with high levels of fluorine. Low levels of fluorine doping are desirable, i.e., 0.1 to 0.4 wt. % fluorine, for example. The resultant fluorine (and potentially chlorine) doped soot tube is then consolidated (step 407).

The consolidated glass tube is then alkali doped (step 404). For example, referring to FIG. 5, the resultant glass tube 106 is preferably first mounted between chucks in a lathe 101 (such as a glass-working lathe or a conventional modified chemical vapor deposition (MCVD) glass-forming lathe). A preferably annular reservoir 108 for receiving an alkali metal source compound 110 is formed near one end of tube 106 by forging two annular neck-like deformations 112 in the wall of tube 106 by flame working or otherwise welding the reservoir to the tube. Other types of reservoir may be also used. Preferably, the annular neck-like deformations 112 are about 2 cm from each other. Preferably, to prevent crystallization of the alkali metal, it is desirable that tube 106, and any additional glass deposited on the inside of tube 106, be essentially chlorine free. By essentially chlorine free we mean exhibiting a chlorine content sufficiently low that optical losses due to alkali chloride crystallization are avoided. A chlorine content preferably less than about 500 ppm by weight is desired for this purpose; more preferably less than about 100 ppm by wt.; and most preferably less than about 50 ppm by wt. In addition, silica glass tube 106, and any additional glass deposited therein, should be essentially free of “water”. By “water” we mean the hydroxyl group OH. Water is responsible for an absorption peak at or about 1383 nm and which absorption peak may extend into the operating wavelength regions of an optical fiber. This peak may have a detrimental effect on the fiber attenuation. Therefore, it is desirable to reduce the absorption peak, also referred to as the water peak, by reducing the OH content of the glass as much as possible. Preferably, glass tube 106 contains less than about 100 ppb by wt. OH; and more preferably less than about 20 ppb by wt. To ensure that starting glass articles are essentially free from water prior to diffusing an alkali metal oxide dopant, conventional chlorine drying techniques may be employed during manufacture of the silica glass tube.

Referring again to FIG. 5, alkali source compound 110 is introduced into tube 106 at reservoir 108 and heated by heat source 114 to form a vapor as tube 106 is rotated. Oxygen or a carrier gas is flowed into the inlet 116 of tube 106 through rotating seal 118, and portion 120 of tube 106 downstream of the alkali metal oxide source compound 110 is heated to facilitate diffusion of the alkali metal oxide into interior surface 122 of tube 106. Preferably, the tube 106 does not have any preform components inserted therein, such as another glass rod or the like. The portion 120 of tube 106 downstream of the alkali metal oxide source compound 110 should be heated to a temperature sufficient to promote rapid diffusion of the alkali into surface 122 and to prevent devitrification of the glass. Preferably, portion 120 of tube 106 downstream of alkali metal oxide source compound 110 is heated by heat source 124 to above 1500° C.; more preferably between about 1500° C. and 2000° C. Preferably, heat source 124 is traversed along the length of portion 120 of tube 106. Alkali metal oxide source compound 112 preferably comprises an element selected from the group consisting of K, Na, Li, Cs, and Rb. Preferably, alkali metal oxide source compound 110 is a bromide, iodide or fluoride. Most preferably, the alkali metal oxide source compound 110 is KBr, KI or KNO₃. The alkali metal oxide (e.g., K₂O, Na₂O, LiO₂, Rb₂O, Cs₂O and mixtures thereof) is preferably diffused throughout a depth of between about 100 microns and 500 microns from the inside diffusion surface 122 of tube 106 prior to collapse of tube 106 thereby forming an alkali oxide doped glass tube. In particular, it is preferred that the diffused alkali metal oxide dopant concentration (in wt. %) in the tube varies radially. Preferably, the glass article (e.g. tube 106) is doped such that the concentration is highest on an inner half portion 107 and lower in an outer half portion 109, as shown in the enlarged view of FIG. 6. The demarcation point between the inner and outer half portions is defined by and located at half the radial thickness (illustrated by dotted line 111) of the tube 106. For example, the diffusion is preferably such that the peak concentration of alkali dopant in the outer half portion 109 is less than 50% of the peak concentration (in wt. %) of the inner half portion 107.

The diffusion process may be followed by the step of further heating tube 106 to promote a partial collapse of tube 106 by conventional methods as are known in the art (or by the dry methods described herein) to both reduce the inside surface area through which the alkali metal oxide might be lost and to thicken the layer of glass into which the alkali metal oxide has been diffused. Once the diffusion doping step, or any partial collapse of tube 106 has been completed, the diffusion surface of the tube 122 may optionally be etched with an etchant, suitable for removing silica glass, to a depth sufficient to remove unwanted impurities that may have diffused through the diffusion surface 122 of the tube. An aqueous HF solution may be used as an etchant, for example. More preferably, a fluoride gas such as, for example, CF₄, SF₆, NF₃, C₂F₆ or a mixture thereof, is employed. The amount of material removed from inner surface 122 is dependent upon processing conditions during diffusion and any partial tube collapse, but the etching conditions are preferably sufficient to result in the removal of glass from surface 122 to a depth of at least about 5 percent of the total diffusion depth of the alkali metal oxide. Once etching is finalized, silica glass tube 106 is further heated with a heat source 1240 to collapse tube 106 downstream of alkali metal oxide source compound 110 and form an alkali metal oxide-doped solid glass rod 132. Collapse of tube 106 is accomplished according to conventional methods known in the art, such as heating with a suitable heat source (e.g., a torch). The solid alkali-doped glass rod 132 is then cut from that portion of glass containing alkali metal source compound reservoir 108. Preferably, the solid alkali metal oxide-doped glass rod 132 is etched with a suitable etchant to remove some or all hydrated glass which may have been formed by the torch during collapse of the tube 106. If a dry heat source is used for collapse, for example, an induction or resistance heater, a plasma torch, or a dry heat source which uses a non-hydrogen containing fuel, such as CO, then etching may not be needed. Utilizing a dry heat source for the doping and/or collapsing steps is believed to minimize re-wetting of the outside of the tube, i.e., diffusing OH (water) into the tube from the outside and may, therefore, further reduce fiber attenuation. A dry heat source is one which does not induce any appreciable OH (water) into the tube.

It should be recognized that the alkali-doped rod 132 when collapsed preferably comprises (similar to the tube 106) concentrations of alkali metal oxide that vary radially and which are such that the portion corresponding to the inner half portion 107 has the highest peak concentration (in wt. %) of alkali dopant and the portion corresponding to the outer half portion 109 has a lower peak concentration. Most preferably, the peak concentration of alkali dopant is at the center of the rod and the concentration at half the radius is less than 50% of the peak concentration; and more preferably less than 25%.

Doped glass rod 132 may be heated in a redraw furnace 136 and drawn into a smaller diameter glass rod 144. This redraw process is illustrated in FIG. 6. A glass handle 130 is attached to the alkali-doped glass rod 132 resulting from the collapse stage described supra and the alkali-doped glass rod 132 is mounted in a moving downfeed support 134 above a conventional redraw furnace 136. A sacrificial glass rod 138, which may be attached to the bottom of alkali-doped glass rod 132, is pulled by motor-driven tractors 140, thereby causing the alkali-doped glass rod 132 to be drawn at a suitable rate. A rate of 15 to 23 cm/min has been found to be adequate, the rate being largely controlled in response to the diameter measured by sensor 142. The outer diameter dimension (d1) of the small diameter glass rod 144 resulting from the drawing process is preferably in the range of 3 mm to 10 mm; more preferably less than 6 mm in diameter dimension. If the diameter dimension of rod 132 resulting from collapse step 426 is within the desired range, rod 132 resulting from collapse step 126 may be used as glass rod 144. The small diameter glass rod 144 should have a peak concentration of K₂O between about 5 times and 10 times the peak K₂O concentration desired in the core of the optical fiber when the optical fiber is drawn, to offset the significant migration of the alkali dopant during draw of the fiber. For example, if the peak K₂O concentration in the optical fiber core is desired to be 0.4 wt. %, the small diameter glass rod 144 preferably should have a peak K₂O concentration between about 2 wt. % and 4 wt. %. In particular, having a very small diameter of the alkali-doped rod is advantageous because this concentrates the transition metal impurities present in the rod very near the fiber's centerline where their negative impact is minimized. It should be recognized that for large amounts of material added to the doped clad, the peak concentration in the fiber could be 100 times less than the peak concentration in the small diameter glass rod. As indicated by step 429 of method 402, once formed, small diameter glass rod 144, according to this method, is further overclad.

For example, as illustrated in FIG. 4, the small diameter alkali-doped_glass rod 144 may be used as a starting rod upon which additional porous glass soot 162 is deposited as overclad using an OVD method, as is known in the art, to form an assembly 160. A typical outside vapor deposition method is illustrated in FIG. 4. As shown in FIG. 4, a glass handle 154 is attached to small diameter alkali-doped glass rod 144 manufactured as heretofore described and becomes an integral part of the resulting preform. Handle 154 provides a method of supporting the silica glass preform resulting from the deposition process during later processing steps. The glass rod 144 having the attached handle 154 is mounted in a lathe where it is rotated and translated with respect to burner 156 which may be, for example, of the type disclosed in U.S. Pat. No. 4,165,223. Fuel gas and oxygen, or air, are supplied to burner 156 from a source (not shown). This mixture is burned to produce a flame which is emitted from burner 156. A silica precursor gas-vapor mixture is oxidized within the flame to form a silica-containing soot stream 158 which is directed toward glass rod 144. Suitable means for delivering the gas-vapor mixture to burner 156 are well known in the art; for an illustration of such means reference is made to U.S. Pat. Nos. 3,826,560, 4,148,621 and 4,173,305. Composite soot preform 160 is formed by traversing glass rod 144 many times with respect to burner 156 to cause a build-up of many layers of silica soot-containing to form soot coating 162. The translating motion could also be achieved by moving burner 156 back and forth along rotating glass rod 144 or by the combined translational motion of both burner 156 and glass rod 144. Soot coating 162 forms at least a portion of the core glass of the composite preform 160 which is preferably comprised of substantially pure silica. Preferably, the soot coating has a density greater than 0.35 g/cc, more preferably between about 0.35 g/cc and 0.5 g/cc. The composite preform 160 is then dried by exposing it to a chlorine-containing gas while being heated in a furnace to a temperature of about 1000C. The preform 160 is then fluorine doped. During the fluorine doping step, the preform 160 is preferably fluorine doped by exposing the preform to a fluorine-containing gas at temperatures (e.g. about 1000C) suitable for causing the soot to become doped with the fluorine. In this way, the outer core region of the optical fiber is formed. However the fluorine doping step is only carried out long enough to allow a relatively small amount of fluorine (0.1 to 0.4 wt %), for example. The preform is then consolidated by heating the preform 160 to a suitable temperature for consolidating the preform. The resultant clear glass core preform may then be redrawn to form a second core rod, i.e. a glass rod which contains at least a portion of the core of an optical fiber drawn therefrom. The second core rod may then further processed by adding additional glass, either by sleeving with a glass tube (either a glass tube or soot tube), through depositing glass soot by chemical vapor deposition, for example, by both sleeving and chemical deposition, or through other methods as are known in the art, to form a complete optical fiber preform ready to be drawn into an optical fiber. The additional glass may comprise core glass, cladding glass or both core and cladding glass. Further, the additional glass may take several additional deposition steps to achieve the desired thickness, wherein after each step, the soot is dried, fluorine doped, consolidated and redrawn into a smaller diameter rod. The outermost cladding, which is preferably the cladding adjacent the core, is silica preferably sufficiently down doped with fluorine by flood doping (see U.S. Pat. No. 4,629,485) to form the cladding region of the optical fiber. The doping is preferably sufficient to achieve a relative refractive index delta % between the core and the cladding of, for example, greater than 0.2%, and more preferably between 0.30% and 0.40%. In particular, for each additional step wherein moat silica (that additional glass corresponding with the cladding of the fiber) is added by deposition to the second rod, such moat silica is doped with fluorine. The moat soot is first dried by subjecting it to a chlorine-containing gas, and then exposed it to a fluorine-containing gas (e.g., SiF₄ or CF₄) for 60-120 minutes at 1225° C. and then consolidated by downdriving through the hot zone (of 1450-1500° C.) at 7-10 mm/min preferably in the presence of the fluorine-containing gas. This preform may be redrawn to form a third rod and the steps repeated again, i.e., deposition, drying, fluorine doping, and consolidation until the proper diameter final preform is achieved. Preferably, the fluorine wt. % in each successive layer of additional glass in the cladding is approximately the same or, more preferably, slightly less (approx. 0.1 to 0.5 wt % less) in the outermost cladding to minimize stress effects. After the complete optical fiber preform of step 467 is manufactured, the completed optical fiber draw preform is drawn into an alkali metal oxide doped optical fiber.

Other methods for making for making fibers are disclosed in U.S. Patent Publication Number 2005/0063663, the specification of which is hereby relied upon and incorporated by reference in its entirety.

In all of the embodiments disclosed herein, the optical fiber preferably comprises a primary coating surrounding and in direct contact with the outermost diameter of the cladding, and a secondary coating surrounding and in direct contact with the primary coating.

It will be apparent to those skilled in the art that various modifications and variations may be made to the present invention without departing from the spirit and scope of the invention. Thus it is intended that the present invention cover the modifications and variations of this invention provided they come within the scope of the appended claims and their equivalents.

What is claimed is:

1. An optical fiber comprising:
a silica-based core, said core comprising an alkali metal oxide selected from the group consisting of K₂O, Na₂O, LiO₂, Rb₂O, Cs₂O and mixtures thereof in an average concentration in said core between about 50 and 1000 ppm by weight, and
a silica-based cladding surrounding and directly adjacent the core, said fiber comprising a cable cutoff less than 1400 nm, chromatic dispersion at 1550 nm between about 13 and 19 ps/nm/km and a zero dispersion wavelength less than about 1420 nm.

2. The optical fiber of claim 1, wherein said fiber exhibits a cable cutoff wavelength less than about 1300 nm.

3. The optical fiber of claim 1, wherein said fiber further comprises an effective area greater than about 70 μm² at 1550 nm.

4. The optical fiber of claim 1, wherein said fiber exhibits a dispersion slope at 1550 nm which is less than about 0.065 ps/nm²/km.

5. The optical fiber of claim 1, wherein said core further comprises fluorine in an average amount greater than about 500 ppm by weight.

6. The optical fiber of claim 1, wherein said core further comprises chlorine in an average concentration in said core greater than about 500 ppm by weight.

7. The optical fiber of claim 1, wherein the core has a refractive index profile with a peak relative refractive index, Δ_{MAX}, greater than 0.3%, relative to the outer cladding.

8. The optical fiber of claim 1, wherein said core further comprising chlorine and fluorine, wherein the average concentration of fluorine in said core is greater than the average concentration of alkali metal oxide in said core and the average concentration of chlorine in said core is greater than the average concentration of alkali metal oxide in said core.

9. The optical fiber of claim 1, wherein said core further consists essentially no germanium.

10. The optical fiber of claim 1, wherein the average concentration of said chlorine in said core is greater than about 500 ppm by weight and the average concentration of said fluorine in said core is greater than about 500 ppm by weight.

11. The optical fiber of claim 1, wherein the core of said fiber comprises a first region located along the centerline of the core which contains chlorine in a minimum amount which is less than 100 ppm, and a second core region surrounding said first region, said second region containing a peak chlorine concentration greater than 500 ppm.

12. The optical fiber of claim 1, wherein the attenuation of said optical fiber at 1550 nm is less than 0.18 dB/km.

13. The optical fiber of claim 1, wherein the attenuation of said optical fiber at 1550 nm is less than 0.17 dB/km.

14. The optical fiber of claim 1, wherein the outer radius of said first region is greater than 3 microns and less than 5 microns.

15. The optical fiber of claim 1, wherein the cladding is doped with fluorine in an average concentration greater than 10000 ppm.

16. The optical fiber of claim 1, wherein the cladding is doped with chlorine in an amount greater than 500 ppm.

17. The optical fiber of claim 1, wherein the alkali metal oxide is K₂O.

18. The optical fiber of claim 1, wherein said fiber exhibits a zero dispersion wavelength greater than about 1300 nm.

19. The optical fiber of claim 1, wherein said fiber exhibits an attenuation of less than 0.18 dB/km at 1550, and the dispersion/attenuation at 1550 nm is between about 80 and 106.

20. The optical fiber of claim 19, wherein the dispersion of said fiber at 1550 nm is less than 16 ps/nm/km.
